(19) United States
(12) Patent Application Publication
(10) Pub. No.: US 2002/0003751 A1
(43) Pub. Date: Jan. 10, 2002

(54) ELECTRONIC SYSTEM HAVING A SELF-SETTING TIME OF DAY CLOCK

(76) Inventor: RONALD D. SMITH, PHOENIX, AZ (US)

Correspondence Address: TIMOTHY N TROP, TROP PRUNER HU & MILES, 8554 KATY FREEWAY, SUITE 100, HOUSTON, TX, 77024

(21) Appl. No.: 09/196,303

(22) Filed: Nov. 19, 1998

(51) Int. Cl. G04B 47/00; G04C 11/02

(52) U.S. Cl. 368/47; 368/10

(57) ABSTRACT

An electronic system includes an antenna, a time of day circuit, a second circuit and a processor. The antenna receives a first indication of a time of day, and the time of day circuit is adapted to furnish a second indication of a time of day. The second circuit is adapted to calibrate the time of day circuit based on the first indication, and the processor is adapted to use the second indication to time stamp operations of the system.

### BACKGROUND

The invention relates to an electronic system having a self-setting time of day clock.

Many electronic systems use the time of day in their daily operations. For example, referring to FIG. 1, a desktop or portable computer 14 may include a time of day (TOD) circuit 24 for purposes of displaying (on a display 9) the time of day and time stamping operations (time stamping the creation of files, for example) of the computer 14. To calibrate the TOD circuit 24 so that the TOD circuit 24 indicates the correct time of day, a user of the computer 14 may enter the current time of day, and the TOD circuit 24 may thereafter maintain an indication of the current time. However, to keep this indication accurate, the TOD circuit 24 typically needs to receive a sufficient level of power. Because the computer 14 may be frequently turned off, the computer 14 may include a battery 22 to provide auxiliary power to the TOD circuit 14 so that the indication of the time is accurate when the computer 14 is turned on again.

Another electronic system that may use the time of day is a digital camera 12. For example, the camera 12 may time stamp an electrical representation of a captured optical image 11 for purposes of authentication. Similar to the computer 14, the camera 12 may include a TOD circuit 20 and a battery 16 to provide backup power when the camera 12 is turned off. The battery 16 may also function as the main power source for the camera 12.

A potential difficulty with the above-described arrangements is that when the backup battery for the TOD circuit fails, the TOD circuit may need to be calibrated to indicate the correct time of day. Furthermore, the backup battery consumes space and contributes to the cost of the electronic system.

Thus, there is a continuing need for an arrangement that addresses one or more of the above-stated problems.

### SUMMARY

In one embodiment of the invention, an electronic system includes an antenna, a time of day circuit, a second circuit and a processor. The antenna receives a first indication of a time of day, and the time of day circuit is adapted to furnish a second indication of a time of day. The second circuit is adapted to calibrate the time of day circuit based on the first indication, and the processor is adapted to use the second indication to time stamp operations of the system.

In another embodiment, a method for use with a computer system includes receiving an RF signal indicative of a time of day. The RF signal is used to calibrate a time of day circuit. The time of day circuit is used to time stamp operations of the computer system.

In yet another embodiment, an article includes a storage medium that is readable by a processor-based system. The storage medium includes instructions to cause a processor to receive an indication of a modulated signal that indicates a time of day and use the modulated signal to calibrate a time of day circuit. The time of day circuit is used to time stamp operations of the system.

### BRIEF DESCRIPTION OF THE DRAWING

FIG. 1 is a schematic diagram illustrating electronic systems of the prior art.

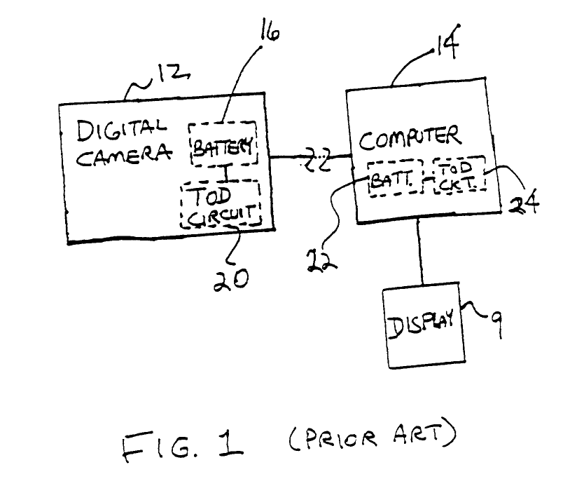

FIG. 2 is a schematic diagram of a camera according to an embodiment of the invention.

FIG. 3 is a schematic diagram of an imager of the camera of FIG. 2.

FIG. 4 is a flow diagram illustrating execution of a program by a processor of the camera of FIG. 3.

FIG. 5 is a schematic diagram of a computer system according to an embodiment of the invention.

### DETAILED DESCRIPTION

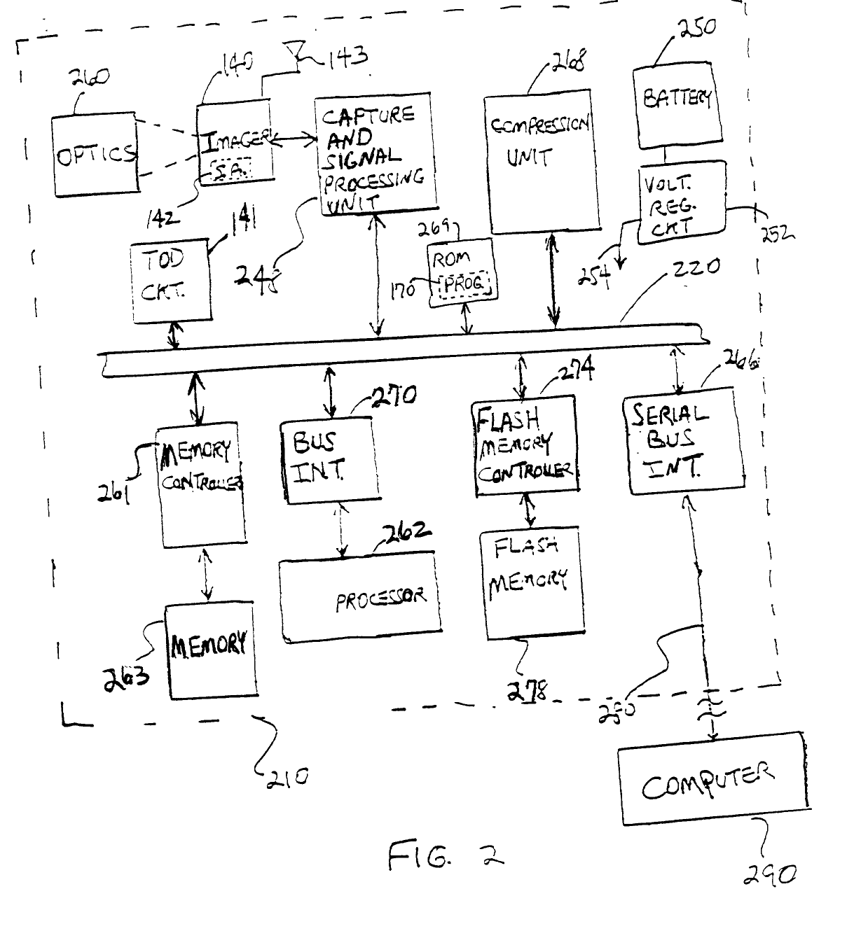

Referring to FIG. 2, an embodiment 210 of a digital camera in accordance with the invention includes a time of day (TOD) circuit 141 that maintains an indication of a current time of day. The camera 210 may use the indication of the current time of day to, as an example, time stamp images that are electrically captured by the camera 210. In this manner, the camera 210 may embed an indication of the time of day into a frame of data that represents the captured image.

In some embodiments, power-consuming components of the camera 210, such as the TOD circuit 141, receive power from a battery 250, and in particular, the TOD circuit 141 may use power from the battery 250 to maintain a substantially accurate indication of the time of day. Unfortunately, the lifetime of the battery 250 is finite, and when the battery 250 is being replaced or fails to provide adequate power, this interruption of power may cause the TOD circuit 141 to no longer maintain a substantially accurate indication of the time of day.

For purposes of reducing the time in which the TOD circuit 141 indicates the wrong time of day, the camera 210 receives a radio frequency (RF) signal (via an antenna 143 and other circuitry described below) that indicates the current time of day. In this manner, the camera 210 uses the RF signal to calibrate, or initialize, the TOD 141 circuit so that the TOD circuit 141 once again maintains a substantially accurate indication of the time of day. Thus, in some embodiments, when the power being received by the TOD circuit 141 is substantially interrupted, the camera 210 subsequently automatically calibrates the TOD circuit 141. Therefore, in some embodiments, an auxiliary battery may not be used, and user intervention to calibrate the TOD circuit 141 may not be needed. The camera 210 may periodically, for example, calibrate the TOD circuit 141 to ensure accuracy of the indicated time, regardless of whether or not power has been interrupted.

In some embodiments, the RF signal may be a modulated (amplitude modulated, phase modulated or frequency modulated, as examples) signal, such as an amplitude modulated signal that the National Bureau of Standards broadcasts at a carrier frequency of approximately 60 kHz. Information about this signal may be obtained from the Time and Frequency Division of the National Institute of Standards (NIST) in Boulder, Colo., or obtained on the Internet at www.boulder.nist.gov/timefreq/pubs/sp432/sp432.htm.

The RF signal may be updated each minute to reflect the correct time. In some embodiments, the camera 210 may monitor the RF signal over a course of a full minute to recover the current time of day. The broadcaster of the RF signal may carefully control the frequency and phase of the RF signal so that the RF signal may be itself an accurate frequency standard that may be used to clock operations of the camera 210.

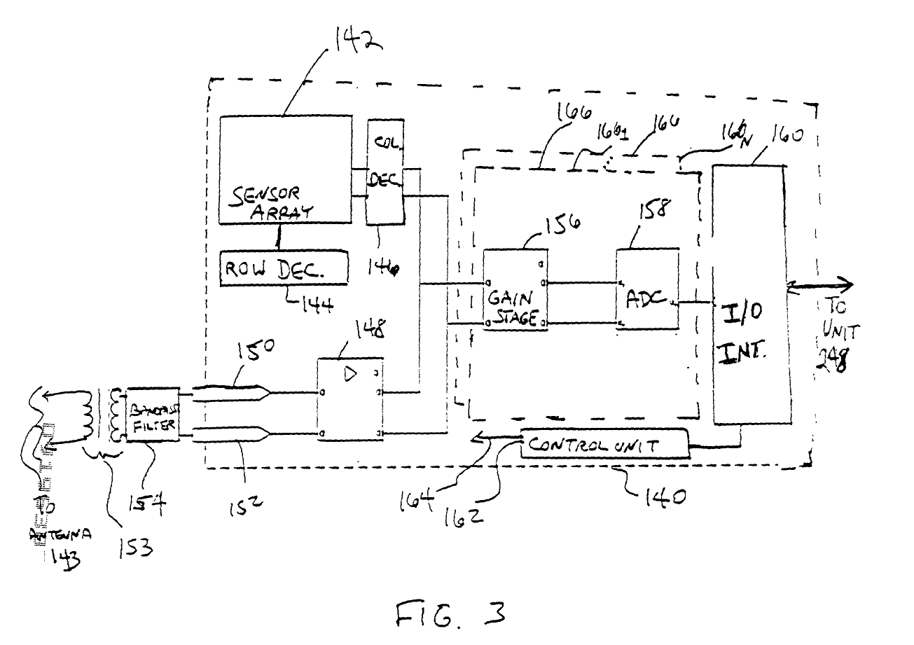

For purposes of receiving the RF signal, in some embodiments, the camera 210 may include a RF receiver and the antenna 143. As an example, the receiver may be formed, in some embodiments, by pre-existing circuitry of an imager 140 of the camera 210. In this manner, a typical imager may be adapted to electrically capture optical images for the camera. However, unlike conventional imagers, the imager 140 may have at least two modes: a receive mode in which the imager 140 furnishes signals that indicate the received RF signal and an image capture mode in which the imager 140 provides signals that electrically indicate a captured optical image. Referring to FIG. 3, more particularly, in some embodiments, the receive mode may utilize pre-existing circuitry (of the imager 140) that is used for the image capture mode.

In particular, in the image capture mode, the imager 140 may use a pixel sensor array 142 (of the imager 140) to electrically capture the optical image. To accomplish this, the array 142 may include pixel sensors that may be arranged in rows and columns. After the array 142 captures the image, each pixel sensor indicates an intensity of a portion, or pixel, of the image.

The indications may be analog voltages that are selectively retrieved from the array 142 by row 144 and column 146 decoders. In this manner, to scan the array (to retrieve the pixel indications), the row decoder 144 may select the rows of the array 142 one at a time. As each row is selected, the column decoder 146 provides the analog voltages of the row to signal conditioning circuitry that converts the analog voltages into digital values that represent the pixel intensities.

As an example, the signal conditioning circuitry may include units 166 (units 166₁ to 166_{N}, for example), each of which converts an analog voltage into a digital value. Each unit 166 may include a gain stage 156 that receives the analog voltage and boosts the voltage to an appropriate level before providing the amplified voltage to an analog-to-digital converter (ADC) 158. The digital values from the units 166 may be provided to an output interface 160 that furnishes the values to circuitry of the camera 210 for further processing.

When in the receive mode, the imager 140 may use one of the units 166 to convert an analog voltage that is provided by the antenna 143 into a digital value that may be further processed by the camera 210, as described below. In particular, in some embodiments, the antenna 143 may be coupled (via a transformer 153, for example) to a bandpass filter 154 that may be external to the imager 140. As an example, in some embodiments, the bandpass filter 154 may be formed from such electronic components as inductors, capacitors and possibly one or more amplifiers. However, in other embodiments, the bandpass filter 154 may be replaced by digital signal processing, such as processing performed by a processor (described below) of the camera 210.

The bandpass filter 154 may be coupled to input pins 150 and 152 (of the imager 140) that are coupled to input terminals of a buffer 148. The output terminals of the buffer 148 may be coupled to the input terminals of the gain stage 156 of one of the units 166. In this manner, the column decoder 146 may share one of the units 166 with the buffer 148. In the receive mode, the buffer 148 uses the unit 166 being shared, and during the image capture mode, the column decoder 146 uses the unit 166 being shared. For both modes, an input/output (I/O) interface 160 provides the resultant digital values to circuitry that is external to the imager 140.

A control unit 162 of the imager 140 may coordinate activities of the imager 140, such as setting the appropriate mode of the imager 140. In particular, the control unit 162 is coupled (via lines 164) to the I/O interface 160, the column decoder 146 and the row decoder 144. As an example, the control unit 162 may receive a request (via the I/O interface 160) to set the mode of the imager 140 to either the image capture mode or the receive mode. The control unit 162 may receive additional commands, such as a command to capture an image, for example.

In some embodiments, the antenna 143 may be an inductive antenna, such as the antenna found in AM band radios, for example. In other embodiments, the antenna 143 may be formed, for example, out of a loop of printed circuit board trace. In some embodiments, the buffer 148 may be a test buffer, and the pins 150 and 152 may be test pins of the imager 140.

The RF signal that is received by the antenna 143 may have a relatively low amplitude that causes the signal that is produced by the buffer 148 to have a low signal-to-noise ratio. However, in some embodiments, because of the sampling requirements imposed by the image capture mode, the ADC 158 may be optimized to sample at a rate that is much higher (100 times higher, for example) than the Nyquist rate of the RF signal. As a result, digital signal processing techniques may be used to recover the RF signal due to the oversampling, even though the signal produced by the buffer 148 may be a very noisy signal. In some embodiments, the bandpass filter 154 or the filter implemented by digital signal processing (as examples) may have a high Q to improve the gain of the RF signal. A high Q for the filter may be practical because the RF signal occupies a relatively small bandwidth. Furthermore, a high Q for the filter, in turn, may permit a less expensive antenna, such as a few coils of a printed circuit trace, to be used.

Referring back to FIG. 2, in some embodiments, the demodulation of the RF signal (to recover an indication of the current time of day) may be performed by a processor 262 of the camera 210. In this context, the term “processor” may generally refer to one or more microprocessors, such as a microcontroller, an X86 microprocessor, an Advanced RISC Machine (ARM) microprocessor or a Pentium® microprocessor, as just a few examples.

As examples, the processor 262 may cause the imager 140 to enter the receive mode after bootup, after the processor 262 detects an interruption of power, after the battery 250 is replaced, or in response to periodic calibration interrupts. When in the receive mode, the imager 140 provides signals that indicate digital values of the RF signal, and the processor 262 may process the digital values to demodulate the RF signal and recover the current time of day. The processor 262 may then use the current time of day to initialize the TOD circuit 141.

There are numerous ways for the processor 262 to determine when power to the TOD circuit 141 has been interrupted. For example, when powered up, the TOD circuit 141 may indicate an un-initialized state, and the processor 262 may periodically read the indication that is provided by the TOD circuit 141 to recognize this state. Another possible way to determine when power has been interrupted, is for the processor 262 to read the indication from the TOD circuit 141 and store the indication in a memory (such as a random access memory (RAM) 263) that loses its stored data when power is interrupted. In this manner, if the power that is received by the memory (and TOD circuit 141) is substantially interrupted, the processor 262 may recognize this occurrence based on the value retrieved from the RAM 263.

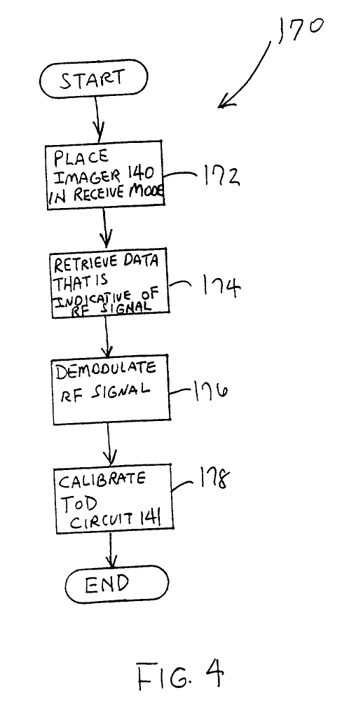

Referring to FIG. 4, in some embodiments, the processor 262 may execute a program 170 upon interruption of power, upon bootup of the camera 210 or periodically, as examples, to calibrate the TOD circuit 141. A copy of the program 170 may be stored, for example, in a read only memory (ROM) 269 (see FIG. 2) of the camera 210, and the program 170, when executed, may cause the processor 262 to behave in the following manner. First, the processor 262 may interact with the imager 140 to place (block 172) the imager 140 in the receive mode. Next, the processor 262 may retrieve (block 174) data from the RAM 263, for example, that is indicative of the RF signal. The processor 262 may perform the above-described filtering functions and may demodulate (block 176) the RF signal to recover the current time of day. Next, the processor 262 may calibrate (block 178) the TOD circuit 141. Copies of the program 170 may be stored on other storage media, such as a floppy disk or a CD-ROM, as examples.

Besides the above-described circuitry, the camera 210 may also include optics 260 to focus the optical image onto the focal plane of the imager 140. A capture and signal processing unit 248 may interact with the imager 140 to capture the pixel image and transfer a frame of data that indicates the pixel image to the RAM 263. To accomplish this, the capture and signal processing unit 248 may be coupled to a bus 220, along with a memory controller 261 that receives the frame from the bus 220 and generates signals to store the data in the RAM 263. The processor 262 may read a value from the TOD circuit to determine the current time of day. Afterwards the processor 262 may embed a code (into the captured frame) that indicates the time at which the image was captured.

The camera 210 may also include a compression unit 268 that may interact with the memory 263 to compress the size of the frame before storing the compressed frame in a flash memory 278. To accomplish this, the compression unit 268 may be coupled to the bus 220, along with a flash memory controller 274 that receives the compressed frame from the bus 220 and generates signals to store the data in the flash memory 278. To transfer the compressed frame to a computer 290, the camera 210 may include a serial bus interface 266 that is coupled to the bus 220 to retrieve the compressed frame from either the RAM 263 or the flash memory 278. The serial bus interface 266 may generate signals on a serial bus 280 (a Universal Serial Bus (USB), for example) to transfer an indication of the compressed frame to the computer 290. The USB is described in detail in the Universal Serial Bus Specification, Revision 1.0, published on Jan. 15, 1996, and is available on the Internet at www.intel.com. The camera 210 may also include voltage regulation circuitry 252 that receives power from the battery 250 and furnishes (via power lines 254) regulated voltages to the power-consuming components of the camera 210, such as the TOD circuit 141. The ROM 269 may be coupled to the bus 220.

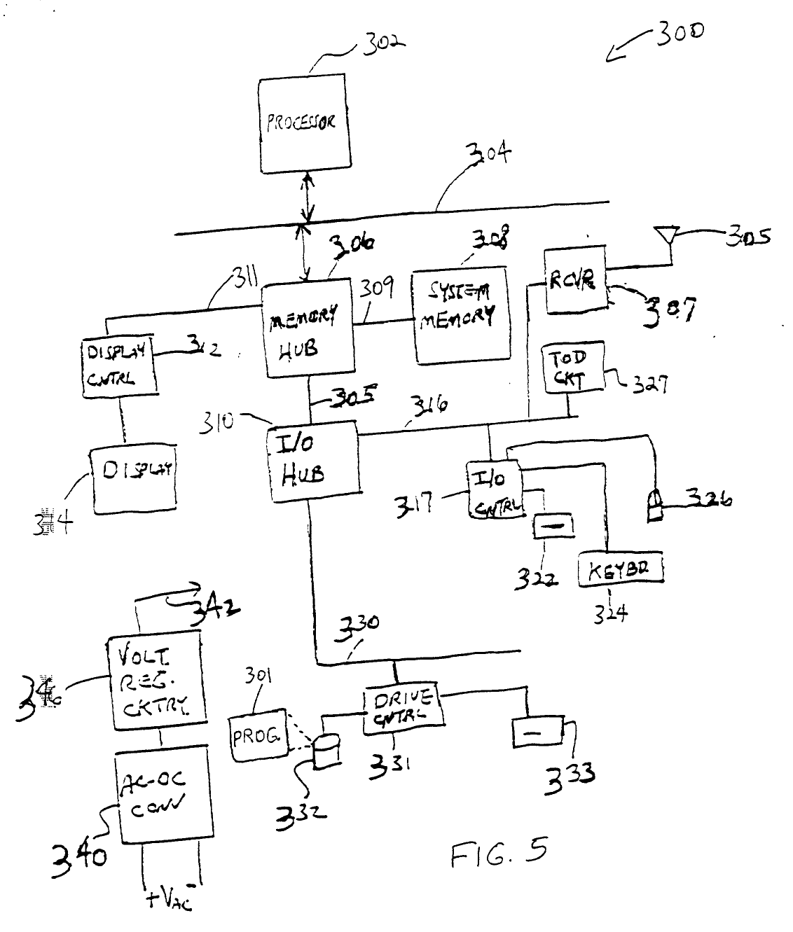

Other embodiments are within the scope of the following claims. For example, referring to FIG. 5, another electronic system, such as a computer system 300, may include a TOD circuit 327 that maintains the current time of day when the computer system 300 is powered up. However, unlike conventional systems, the computer system 30 does not include a battery for purposes of supplying power to the TOD circuit 327 when the computer system 300 is turned off. Instead, the computer system 300, in some embodiments, may include a receiver 307 that is coupled to an antenna 305 to receive the RF signal. The receiver 307, in turn, may furnish signals that digitally indicate the RF signal.

In this context, the term “computer system” generally refers to a system that includes a processor (a microcontroller, an X86 microprocessor, an Advanced RISC Machine (ARM) microprocessor or a Pentium microprocessor, as examples) and may be (but not limited to) a desktop computer, a portable computer (a laptop computer, for example) or an appliance, as just a few examples.

As an example, the receiver 307 may have a design that is similar in design to the receiver formed by circuitry of the imager 140 and the bandpass filter 154 that are described above. The TOD circuit 327 and the receiver 307 may be coupled to an input/output (I/O) expansion bus 316 that is coupled via circuitry (described below) to a processor 302. In this context, the term “processor” may refer to, as examples, to at least one microcontroller, X86 microprocessor, Advanced RISC Machine (ARM) microprocessor or Pentium microprocessor. Other types of processors are possible and within the scope of the following claims.

The processor 302 may perform signal processing functions, such as demodulation of the RF signal and recovery of the time of day that is indicated by the RF signal. As an example, the processor 302 may perform a background process to calibrate the TOD circuit 327 when the processor 302 determines power to the TOD circuit 327 has been substantially turned off, as described above for the camera 210. The processor 302 may also calibrate the TOD circuit 327 at other times, such as on bootup of the computer system 300 or periodically, as just a few examples. In the calibration, the processor 302 may, for example, execute a copy of a program 301 that is stored in a hard disk drive 332 of the computer system 300. As an example, the program 301 may cause the processor 302 to perform similar functions to the functions performed by the processor 262 (of the camera 210) when the processor 262 executes the program 170, described above. Copies of the program 301 may be stored on other storage media, such as a floppy disk or a CD-ROM, as examples.

The processor 302 may read a value from the TOD circuit 327 that indicates the current time of day and use the value to time stamp operations of the system 300, such as file operations, for example. The processor 302 may use the TOD circuit 327 to time stamp other operations of the system 300, such as the time at which a particular e-mail is received, for example.

In some embodiments, the computer system 300 may include a bridge, or memory hub 306. The processor 302 and the memory hub 306 may be coupled to a host bus 304. The memory hub 306 may provide interfaces to couple the host bus 304, a memory bus 309 and an Accelerated Graphics Port (AGP) bus 311 together. The AGP is described in detail in the Accelerated Graphics Port Interface Specification, Revision 1.0, published on Jul. 31, 1996, by Intel Corporation of Santa Clara, Calif. A system memory 308 may be coupled to the memory bus 309, and a display controller 312 (that controls a display 314) may be coupled to the AGP bus 311. A hub communication link 305 may couple the memory hub 306 to another bridge circuit, or input/output (I/O) hub 310.

In some embodiments, the I/O hub 310 includes interfaces to the I/O expansion bus 316 and a Peripheral Component Interconnect (PCI) bus 330. The PCI Specification is available from The PCI Special Interest Group, Portland, Oregon 97214. An I/O controller 317 may be coupled to the I/O expansion bus 316 and receive input data from a keyboard 324 and a mouse 326, as examples. The I/O controller 317 may also control operations of a floppy disk drive 322. A drive controller 331 may be coupled to the PCI bus 330 and may control operations of the hard disk drive 332 and a CD-ROM drive 333, as examples. The computer system 300 may also include voltage regulation circuitry 346 that receives power from an AC-DC converter 340 that receives AC power. The voltage regulation circuitry 346 furnishes (via power lines 342) regulated voltages to the power-consuming components of the computer system 300, such as the TOD circuit 327.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. An electronic system comprising:
an antenna to receive a first indication of a time of day;
a time of day circuit adapted to furnish a second indication of a time of day;
a second circuit adapted to calibrate the time of day circuit based on the first indication; and
a processor adapted to use the second indication of the time of day to time stamp operations of the system.

2. The electronic system of claim 1, further comprising:
a battery adapted to furnish the power.

3. The electronic system of claim 1, wherein the time stamp operations comprise:
file operations.

4. The electronic system of claim 1, wherein the first indication comprises a National Bureau of Standards signal.

5. The electronic system of claim 1, wherein the electronic system comprises a camera.

6. The electronic system of claim 1, wherein the electronic system comprises a computer system.

7. The electronic system of claim 1, wherein the processor forms part of the second circuit.

8. The electronic system of claim 1, wherein the first indication comprises a frequency modulated signal.

9. A camera comprising:
an array of pixel sensors adapted to capture an optical image;
an antenna to receive a first indication of a time of day;
a time of day circuit adapted to maintain a second indication of a time of day;
a second circuit adapted to calibrate the time of day circuit based on the first indication; and
a processor adapted to:
cause the array to capture the optical image to form a frame of data; and
use the second indication of the time of day to time stamp operations of the processor.

10. The camera of claim 9, wherein
the processor forms part of the circuit,
the time of day circuit receives power, and
the processor is further adapted to:
determine if the power received by the time of day circuit has been substantially interrupted, and
calibrate the time of day circuit based on the determination.

11. The camera of claim 9, further comprising:
a battery to provide power to the time of day circuit.

12. The camera of claim 9, wherein the receiver comprises at least a portion of an imager.

13. The camera of claim 9, wherein during a first mode, the imager provides signals representing the first indication and during a second mode, the imager provides signals representing the optical image.

14. The camera of claim 9, wherein the first indication comprises a frequency modulated signal.

15. The camera of claim 9, wherein the first indication comprises a phase modulated signal.

16. The camera of claim 9, wherein the first indication comprises an amplitude modulated signal.

17. The camera of claim 9, wherein the operations comprise an operation of capturing an image.

18. The electronic system of claim 9, wherein the first indication comprises a National Bureau of Standards signal.

19. A method for use with a computer system, comprising:
receiving an RF signal indicative of a time of day;
using the RF signal to calibrate a time of day circuit; and
using the time of day circuit to time stamp operations of the computer system.

20. The method of claim 19, wherein the act of using comprises:
reading a value indicative of the time of day from the time of day circuit.

21. The method of claim 19, wherein the act of using comprises:
periodically using the RF signal to calibrate the time of day circuit.

22. The method of claim 19, wherein the RF signal comprises a National Bureau of Standards signal.

23. The method of claim 19, wherein the act of using the RF signal comprises:
demodulating the RF signal.

24. An article comprising a storage medium readable by a processor-based system, the storage medium comprising instructions to cause a processor to:
receive an indication of a modulated signal that indicates a time of day;
use the modulated signal to calibrate a time of day circuit; and
use the time of day circuit to time stamp operations of the system.

25. The article of claim 24, comprising:
instructions to cause the processor to demodulate the modulated signal.

26. The article of claim 24, wherein the operations comprise file operations.

27. The article of claim 24, comprising:
instructions to cause the processor to periodically calibrate the time of day circuit.

28. The article of claim 24, wherein the modulated signal comprises a National Bureau of Standards signal.
